(19) United States
(12) Patent Application Publication
(10) Pub. No.: US 2021/0280894 A1
(43) Pub. Date: Sep. 9, 2021

(54) STARWHEEL-ENABLED ASSEMBLING OF LONG-LIFE BATTERIES

(71) Applicant: James E. Beecham, West Palm Beach, FL (US)

(72) Inventor: James E. Beecham, West Palm Beach, FL (US)

(21) Appl. No.: 17/108,969

(22) Filed: Dec. 1, 2020

Related U.S. Application Data
(63) Continuation-in-part of application No. 17/102,226, filed on Nov. 23, 2020.
Application No. 17/102,226 is a continuation-in-part of application No. 17/092,035, filed on Nov. 6, 2020.
Application No. 17/092,035 is a continuation-in-part of application No. 17/064,243, filed on Oct. 6, 2020.
Application No. 17/064,243 is a continuation-in-part of application No. 17/033,853, filed on Sep. 27, 2020.
Application No. 17/102,226 is a continuation-in-part of application No. 16/867,273, filed on May 5, 2020, now Pat. No. 10,800,434.
(60) Provisional application No. 62/986,682, filed on Mar. 7, 2020.

(51) Int. Cl. H01M 10/04; H01M 50/213; H01M 50/249

(52) U.S. Cl. CPC H01M 10/0409; H01M 2220/20; H01M 50/249; H01M 50/213

(57) ABSTRACT

system and method for assembling tong-life cylindrical batteries. Assembly comprises use of jelly rolls of battery materials comprised of fold over tabs at end plate periphery, said tabs useful to maintaining relatively short electron paths and to maintaining electrical connections, to benefit of long useful life of battery. In a preferred embodiment, at least one starwheel enables movement and positioning of cylindrical battery cases during assembly. In a preferred embodiment, such correct positioning of battery cases enables them to receive placement of jelly roll of battery materials and to receive battery caps. Assembly comprises use of jelly rolls of battery materials comprising end plates configured of extensions of electrode in face-to-face shingle-style overlaps. Said tight overlaps, held in place by tabs, enable secure electrical connections to be maintained over long life of battery, and comprise mitigation against overheating of battery during rapid charge or discharge, thus reducing likelihood of fire.

### CROSS-REFERENCE To RELATED APPLICATION

The present invention claims priority to non-provisional application Ser. No. 17/102,226 filed 23 Nov. 2020 by instant inventor, entitled CONFIGURING AND MAINTAINING SHINGLED OVERLAPS OF ELECTRODE EXTENSIONS AT END PLATE OF JELLY ROLL OF BATTERY MATERIALS, which claims priority to non-provisional application Ser. No. 17/092,035 filed 6 Nov. 2020 by instant inventor, entitled ELECTRODE EXTENSION OVERLAP CONFIGURATIONS IN BATTERY, which claims priority to non-provisional application Ser. No. 17/064,243 filed 6 Oct. 2020 by instant inventor, entitled ELECTRIC VEHICLE BATTERY PACKS COMPRISING TABLES/MULTI-TAB CYLINDRICAL JELLY-ROLL STYLE BATTERY CELLS, which claims priority to non-provisional application Ser. No. 17/033,853 filed 27 Sep. 2020 by instant inventor, entitled ELECTRIC VEHICLE SAFETY AS TO SIDE COLLISIONS AND BATTERY PACK PLACEMENT IN MANUFACTURING, which claims priority to non-provisional application Ser. No. 16/867,273 filed 5 May 2020 by instant inventor, entitled A METHOD AND SYSTEM FOR MITIGATING ANTICIPATED RISKS IN SELF-DRIVING VEHICLES VIA USE OF MALICIOUS ROADWAY FALSIFIED APPEARANCES now issued U.S. Pat. No. 10,800,434 of 13 Oct. 2020, which claims priority to provisional application Ser. No. 62/2986682 filed Mar. 7, 2020, hereby each referenced publication is incorporated in its entirety at least by reference.

### FIELD OF THE INVENTION

The present invention generally relates to batteries. More specifically, the present invention relates to starwheel-enabled assembly of long-life batteries.

### BRIEF SUMMARY OF THE INVENTION

As background, cylindrical batteries power devices and more than one million electric vehicles on the road today. It is estimated that in future, electric vehicles will be manufactured in tens of millions per year. The need exists to develop automated high-throughput assembly lines for cylindrical batteries having long life, such as by battery comprising mitigation against overheating and preservation of short average electron path length.

In a preferred embodiment, instant invention comprises at least semi-automated assembly of cylindrical batteries. In a preferred embodiment, said assembly comprises using jelly rolls of battery materials, cylindrical battery cases and battery caps. In a preferred embodiment, said assembly comprises placing such wound jelly rolls into individual battery cases, and attaching caps to said jelly roll-containing cases.

In a preferred embodiment, instant invention assembly line is powered by electricity, at least in part. In a preferred embodiment, instant invention assembly lines within scope of instant invention are enabled by methodology and system machinery modified from that well-known in industry, such as the bottle filling and capping industry.

In a preferred embodiment, instant invention system comprises at least one assembly line capable to produce, from jelly rolls of battery materials, battery cases and caps, at least 200 assembled long-life cylindrical batteries per hour, and optionally many more. In a preferred embodiment, instant invention system comprises assembly of cylindrical batteries comprised of short average electron pathway length. It is understood that configuring a battery of short average electron path length increases likelihood said battery will have a long useful life.

A relatively short average electron path length in a battery constitutes mitigation against overheating of said battery, such as during rapid charge or discharge. In a preferred embodiment, said short average electron path length is herein enabled in assembled batteries by comprising said batteries of end plates comprised of face-to-face shingle-style overlapped electrode extensions. In a preferred embodiment, at least one end plate's majority is comprised of face-to-face shingle-style overlaps of electrode extensions. In a preferred embodiment, the ends of the typical end plate's overlapped extensions, together present a virtually solid appearance of tightly packed overlaps across at least the majority of expanse of the end plate, as viewed from above the jelly roll. In a preferred embodiment, at the periphery of such virtually solid appearance are folded over tabs right around the edges of the end plate, securing it.

In a preferred embodiment, said end plates of instant invention typically comprise at least one folded over tab at end plate to at least assist end plate to resist unraveling. By maintaining said end plate's tight face-to-face shingle-style overlaps of electrode extensions, end plates remain compact, with preserved electrical connections. Such maintaining of electrical connections serves the function of comprising battery of relatively short average electron path length, increasing likelihood for long useful life of battery.

In a preferred embodiment, maintaining at least relatively short average electron path length in batteries assembled within instant invention, said maintaining comprises mitigation against risk of overheating to cause fire. For more details, please refer to cited reference non-provisional application Ser. No. 17/102,226 filed 23 Nov. 2020 by instant inventor, entitled ‘Configuring and maintaining shingled overlaps of electrode extensions at end plate of jelly roll of battery materials’.

In a preferred embodiment, instant invention system comprises at least one aspect of assembly line comprising starwheel-enabled movement imparted to battery cases during assembly process. In a preferred embodiment, said movement comprising at least one of list: rolling along track comprised of guide rails, stop and go motion, rotary motion associated to starwheel.

A starwheel comprises a rotary orienting device typically comprised of a solid plastic wheel with pockets machined into the wheel at given intervals. Said starwheel pockets are typically used to hold, at least temporarily, one or more specific battery cases being addressed in instant invention manufacturing process steps. In a preferred embodiment, for example, automatic chuck capping machine use n intermittent (stop and go!) starwheel to correctly position the to-be-capped battery case(s) under the chuck capping head(s).

Once rendering the battery case into correct position, the starwheel stops, the chuck descends, and the cap is placed onto the said correctly positioned battery case. The starwheel will then begin to move once again, stopping when the next battery case is correctly positioned.

In a preferred embodiment, other uses for starwheels within instant invention comprise means to raise elevation of battery cases, such as to enable the cases to exit interactive starwheel at higher level. Such higher level can allow cases to proceed on gravity fed track to subsequent part of assembly line. Interactive starwheels comprise a pair of starwheels wherein battery cases transit from a notch portion of a first starwheel to transfer to second starwheel notch position.

In a preferred embodiment, batteries assembled on instant invention assembly line(s) comprise end plates on jelly rolls of battery materials. In a preferred embodiment, typical end plate of instant invention is comprised of at least one folded over tab per end plate, and typically a dozen or more around the periphery of the end plate. In a preferred embodiment, tabs are folded over end plate, at least assisting end plate to resist unraveling. By maintaining compactness of end plates, tabs help secure the end plate's integrity of electrical connections.

In a preferred embodiment, said fold over tabs secure the compactness and maintain tight packing of end plate's shingle-style overlapping of extensions of electrode. By such compactness and maintaining, end plate's contribution to long battery life and vehicle safety against fire is enabled, It is understood that batteries assembled per instant invention are suitable for use in energy storage applications, as well as in industry and home uses and the like.

In a preferred embodiment, said fold over tabs' origin can comprise at least one of list: origin as extensions of electrode, origin from jacket or wrap applied to jelly roll, origin from circumferential or partial circumferential band, origin from battery case material. For more details, please refer to cited reference non-provisional application Ser. No. 17/102,226 filed 23 Nov. 2020 by instant inventor, entitled ‘Configuring and maintaining shingled overlaps of electrode extensions at end plate of jelly roll of battery materials.’

In a preferred embodiment, the instant invention further comprises at least one capping action, said action enabling a cap to be attached to an individual battery case which contains a jelly roll of battery materials. Said battery cap comprises means to enable establishment of electrical connection between battery and external circuit. In a preferred embodiment, said capping action occurs associated to action of at least one starwheel, as will be further disclosed below.

In a preferred embodiment, the instant invention method comprises configuring cylindrical lithium ion batteries in metal cases, said method comprising steps: providing a plurality of jelly rolls of battery materials, each roll properly wound and wrapped, each such roll comprising at least one end plate comprising compact face-to-face shingle-style overlapped electrode extensions and fold over tabs. In a preferred embodiment, said method uses at least one motorized bobbin to wind jelly rolls of battery materials and wrap them with non-conductive wrap. In a preferred embodiment, said method places said individually wrapped rolls into individual metal cases. In a preferred embodiment, said method enables attaching of individual caps onto said roll-comprised metal cases.

In a preferred embodiment, said method further comprises step of comprising at least one end plate per jelly roll of battery materials with at least one fold-over tab. In a preferred embodiment, said at least one tab arises from item of list: electrode as extension, jacket or wrap applied to wound jelly roll, at least partial circumferential band applied to jelly roll, battery case.

In a preferred embodiment, said method further comprises step of correctly positioning battery cases for at least one step of method, such step comprising at least one of list: capping battery cases, inserting wound jelly roll of battery materials into battery case. In a preferred embodiment, said positioning comprises stop and go motion of at least one starwheel in said positioning of battery cases.

In a preferred embodiment, instant invention method comprises rolling of battery cases down a gravity fed track comprised of guard rails. In a preferred embodiment, instant invention method comprises step of configuring at least one battery as comprised of two end plates.

In a preferred embodiment, said method further comprises step of configuring said assembly line of capacity to cap at least 200 battery cases per hour. In a preferred embodiment, said method further comprises step of configuring said assembly line of capacity to fill at least 200 metal cases per hour, such filling comprising placing one each wound jelly roll of battery materials into individual battery case.

In a preferred embodiment of instant invention, system comprises battery metal cases rolling along a curved track having guard rails. in a preferred embodiment, instant invention method comprises using at least a first starwheel which interacts with at least a second starwheel, to enable useful battery case movement.

In a preferred embodiment, said interacting starwheels enable transitioning a battery case from moving radially on a first starwheel, to moving radially on a second starwheel. In a preferred embodiment, said interacting starwheels enable transitioning a battery case from moving radially on a starwheel to rolling along a curved track with guard rails. In a preferred embodiment, instant invention method comprises enabling stopping of movement of a battery case momentarily to enable at least one of list: placement of jelly roll of battery materials into said battery case, placement of a battery cap on jelly-roll-containing battery case.

In a preferred embodiment, system of instant invention comprises folded-over tabs at periphery of end plate of jelly roll of at least one battery. In a preferred embodiment, system of instant invention comprises assembly of battery comprised of at least one jelly roll of battery materials comprised of at least one end plate having folded over tabs, and same end plate comprised of plurality of compact face-to-face shingle-style overlaps of electrode extensions.

### BRIEF DESCRIPTION OF THE FIGURES

Other features and advantages of the present invention will become apparent when the following detailed description is read in conjunction with the accompanying drawings, in which:

FIG. 1 is a schematic illustrating details of a preferred embodiment.

FIG. 2 is a schematic illustrating details of a preferred embodiment.

### DETAILED DESCRIPTION OF PREFERRED EMBODIMENTS

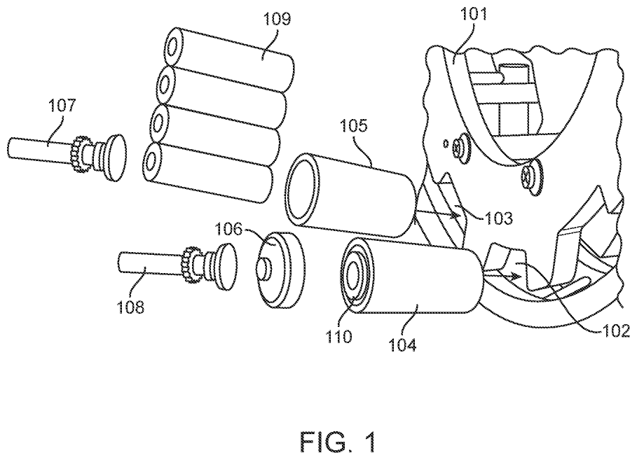

In FIG. 1, a schematic illustrates a preferred embodiment of instant invention wherein elements of, and coordination of, assembly line for assembling long-life batteries are schematically represented. First representation, at top left of drawing, comprises a stack of four representative jelly rolls of battery materials 109. Said four rolls represent the reservoir of this element feeding the assembly process, i.e. a line of jelly rolls rendered into alignment, such as one at a time, to be inserted into battery cases by the insertion mechanism, here represented by plunger 107. It is understood that the supporting structures, such as frame of metal scaffolding and bins and feeding chutes, and the like, are present and configured to purpose as is well-known in the art. It is understood that gears and motorized drives are also present, along with control mechanisms and optionally with computer control, as is well-known in the bottling industry and herein modified to purpose of battery assembly.

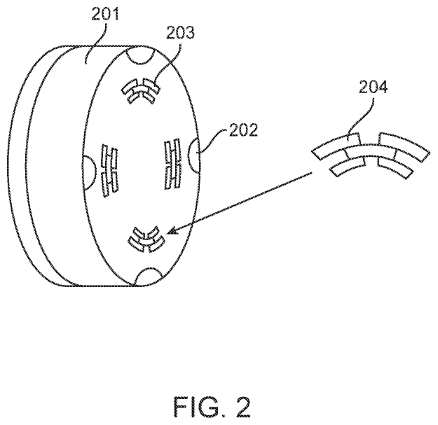

Each jelly roll comprises at least one end plate. Each end plate comprises extensions of electrode, here viewed in end on perspective schematic, in format representing compact face-to-face shingle style overlap of said extensions. End plate also comprises plurality of folded over tabs at periphery (see FIG. 2 for details of end plate).

The stack of jelly rolls is aligned to permit lowest roll of stack to be acted upon by plunger 107, which plunger represents one of several well-known inserting mechanisms useful (not shown) within instant invention assembly lines, wherein a first element (jelly roll) is propelled at proper time and inserted into a second element (battery case). Insertion is timed in relation to stop and go motion of starwheel 101.

Said starwheel 101 comprises machined plastic wheel on axis, enabled by system control to perform timed counterclockwise rotary stop and go motion. Starwheel 101 comprises notches 103 and 102, suitable to hold battery cases 105 and 104, respectively. The starwheel's rotary motion in a stop and go movement is understood to move case after case into position for filling and capping.

In this illustration, starwheel 101 is in a stop position wherein the battery case 105 is positioned to receive insertion of jelly roll from stack 109, and the battery case 104 having jelly roll inside, is positioned to receive attachment of battery cap 106. Said stop position of starwheel 101 was reached after the previous go motion of wheel rotated counterclockwise one notch-worth of rotary motion. Said one notch-worth of rotary motion positioned the notch 103 occupant battery case 105 to be in position to receive a jelly roll. Said same one notch-worth of starwheel counterclockwise rotation also positioned the notch 102 occupant battery case 104 to be in position to receive a cap.

Thus, it is understood that the stop and go one-notch at a time rotary motion of preferred embodiment starwheel 101, said motion positions battery case after battery case into correct position to enable said insertion of jelly roll and then said capping to occur to each battery case in turn. Plunger 107 represents the mechanism of inserting. Plunger 108 represents the mechanism of capping.

Battery cap 106 represents the reservoir of battery caps and the mechanism of positioning cap to enable capping mechanism to attach it to case. The position illustrated for battery cap 106, i.e. over case 104 located in notch 102, this coordinated positioning represents the timing of cap reservoir and feed mechanism to position a cap in coordination to starwheel 101 rotary motion. Thus, it is understood that a cap, rendered into position for capping case 104, such action is timed to occur as the starwheel rotary motion counterclockwise renders battery case 104 into stopped position suitable to receive said cap 106.

Battery cap attachment represented is understood to be accomplished and secured in place by one of a variety of well-known in the art means of attaching. For example, said attachment can comprise use of adhesive, or a mechanism of ‘snap-on’ type wherein cap secures to snap-receiving mechanism at the battery case, or a twist-on mechanism wherein plunger grips and swivels the cap onto a receiving groove of the battery case, or spot welding mechanism (not shown). It is understood that the cap attaching step can be a separate notch position step from the cap placing.

The control mechanism for timing, and the power supply which enable the mechanisms herein illustrated, these are accomplished by means well-known in the art (not shown). For example, the power supply is typically electric grid supply, and the movements are enabled by computer control of gears and the use of sensors to verify steps.

As starwheel rotates a further notch-worth from the position illustrated in FIG. 1, it is understood that case 105 next stops at capping position, and receives a cap. It is understood that case 104 moves in radial movement within notch 102 until said case 104 reaches the exit point for movement of case off starwheel 101 and on to next part of assembly sequence. Said next part of sequence can be as a second interacting starwheel which removes case 104 from its notch in starwheel 101 and takes it into notch of said second starwheel. Such second starwheel can transfer, via its radial moving of case 104, said case to higher elevation wherein case 104 is guided to roll along track with guard rails to collection point of finished batteries.

In a preferred embodiment, movements of battery cases within system thus comprise at least one of list: stop and go, radial, rolling along track, moving from one starwheel's notch position to a second interacting starwheel's notch position, movement aligning case with jelly roll filling position, movement aligning case with capping position. Radial movement is defined as motion at a right angle to an axis of rotation. Essentially, radial motion is the movement around a shaft rather than along its length.

It is understood that instant invention assembly lines can be comprised in a variety of configurations, each within scope of instant invention. In a preferred embodiment, such configurations and arrangements typically comprise mechanisms which can be thought of as three lines of parts supply and configuring. Jelly rolls of battery materials comprised of end plates as disclosed herein, battery caps, and battery cases, these are each supplied and rendered into correct position for assembly simultaneously. Actions follow, by which filling, and capping occur in coordination to progressive movement of battery cases. Finished batteries are delivered to collecting point.

Although the illustration in FIG. 1 is of filling and capping performed when starwheel is stopped, in a preferred embodiment the filling and/or capping is accomplished as line of battery cases continues to move. Such moving line filling and/or capping is rendered by in-line filling mechanism and/or in-line capping mechanism, as are well-known in the art of bottling, and modified for battery assembly use herein. For example, a line/reservoir of stacked rolls, and a line/reservoir of stacked caps, each feed and coordinate with in-line mechanisms of motion coordination, to accomplish assembly of batteries. Such in-line mechanisms complete the filling and attaching actions while moving parts of said filling and attaching mechanism also move in coordination to the moving receiving line of battery cases (not shown). Such moving line placement typically enables greater throughput of finished batteries as compared to stop and go motion assembly.

In a preferred embodiment, moving insertion of jelly rolls of battery materials into battery cases, is accomplished comprising a moving line of battery cases aligned to an in-line filler mechanism dispensing jelly rolls. In a preferred embodiment, affixing of caps onto battery cases, is accomplished comprising a moving line of battery cases aligned to in-line capping mechanism.

In FIG. 2, a preferred embodiment is illustrated in schematic form, said schematic illustrating an end plate of jelly roll of battery materials of instant invention's long-life battery. Said end plate 201 comprises a compact assembly of overlapped extensions of an electrode of said battery. At 203 is illustrated a representation of five compactly assembled overlapped extensions typical of overlapped extensions of instant invention. The schematic illustrates 4 such groups of 5 extensions as examples across the expanse of the end plate. These represent what are typically dozens, and up to a hundred or more extensions in tight overlap across the full expanse of the typical end plate. Visible in this perspective view, as ends of extensions in tight overlap, such 4 groups of 5 tightly overlapped extensions have a face-to-face shingle type of overlap. Please see details in non-provisional application Ser. No. 17/102,226 filed 23 Nov. 2020 by instant inventor, entitled ‘Configuring and maintaining shingled overlaps of electrode extensions at end plate of jelly roll of battery materials.’

It is understood that the full expanse of the typical end plate of instant invention's long-life battery is comprised of overlapping extensions of electrode. The schematic conveys this by illustrating groups. For the actual end plate, a surface appearance would be comprised of ends of extensions visible as overlapping and compacted across the expanse. The typical overlap format is illustrated by schematic of a group at 204.

To convey the said full expanse nature of these overlaps across the full end plate in typical end plate, four groups of five tightly compacted extensions 203 are schematically illustrated. These ends of extensions are meant n illustration, to reflect the result of winding of the jelly roll. Such winding of parallel extensions renders them in compact overlap. It is understood that said extensions are viewed in FIG. 2 in perspective view in which the top edges of said extensions are seen, as opposed to faces which are not seen but understood to be overlapped face-to-face with other extensions within the full end plate.

The tight compactness of overlapped extensions is represented by the closeness of the top edges of the 5 extensions in each of the 4 groups. Such compactness, tightness, and closeness of application of said extensions across the end plate, i.e. the face-to-face shingle-style overlapping, is important to be maintained in place during the working life of the battery. Such maintaining enables long life of the battery. To accomplish such maintaining, tabs 202 assist in such maintaining of compactness of end plate, as is further described below. The tabs typically are aligned around the entire end plate periphery but are schematically represented here by 4 tabs. Each tab is folded over the periphery of the end plate and snuggly onto it, to preserve the overlap of the extensions.

The extensions on end view are seen to have each a typical slightly curved configuration, as illustrated, for example, at 204. Such slightly curved nature enables the tight overlaps of extensions, which tightness serves to enable the electrical connections between and among the extensions. Such electrical connections enable multiple electron paths, which enables heat mitigation for the battery. By preserving said plurality of electrical connections, the battery is enabled to maintain short average electron path length. Thus, the battery is enabled to longer useful life. The tabs preserve this arrangement of extensions, by securing the end plate from unraveling.

In a preferred embodiment, fold-over tabs 202 are illustrated here as four tabs. Such illustration is understood to be representative of a dozen tabs or more per typical end plate. Such illustration is understood to be representative of folded down tabs around the full periphery of the typical end plate. Said tabs are typically comprised of durable material, such as metal. Such tabs secure the end plate and its function, as discussed herein.

Although the invention has been described in considerable detail in language specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention.

A portion of the disclosure of this patent document contains material which is subject to copyright protection. The copyright owner has no objection to the facsimile reassembly by anyone of the patent document or the patent disclosure, as it appears in the Patent and Trademark Office patent file or records, but otherwise reserves all copyright rights whatsoever.

What is claimed is:

1-20. (canceled)

21. A system for assembling finished batteries from battery parts, said system comprising at least one mechanism at least consistent with derivation/adaptation from automated industrial bottling systems and mechanisms, said at least one derived/adapted battery assembling mechanism of list:
capping chuck automatically positioned to automatically cap battery case;
at least one capping chuck coordinated in timing to correct cap-receiving position of battery case;
automated feeding of battery parts into at least one battery assembly line;
computer control of at least one of gears, motorized drives, and automated mechanisms for battery assembly;
automatic movement of at least one battery case into desired position for assembly, said moving comprising rotary motion of at least one starwheel;
at least one battery case coordinated to automatic receipt of insertion of jelly roll of battery materials;
continuous motion assembly sequence automated for at least one battery case, during which sequence case moves to enable automatic attachment of battery cap;
at least a first battery part induced to mutual coordinated motion to align with at least a second battery part in enabling automatic assembly;
battery cap automatically induced to attachment to battery case, such attachment enabled by one of list: adhesive, pressure/snap-on motion, swivel/twist-on motion, receiving groove;
battery parts in automated transit during battery assembly, said transit comprising sensor control;
sensors verifying automated steps during battery assembly;
multiple lines of battery parts supply configured and arranged in automated assembly, comprising computer control of battery caps, and battery cases;
coordination mechanism for enabling placement of jelly rolls of battery materials into battery cases, said mechanism of coordination comprising at least one mechanism derivable from liquid filling line mechanisms of bottling industry;
coordination mechanism for enabling capping of battery cases, said mechanism of coordination derivable from bottle-capping mechanism in bottling industry;
battery parts automated motion comprising use of interacting starwheels.

22. The system of claim 21, further comprising at least one said derived/adapted mechanism of list:
battery case in correct position to enable insertion of jelly roll of battery materials,
battery case in correct position to enable capping,
functions of filling, and capping coordinated to progressive movement of battery cases.
finished batteries delivery to collecting point,
accomplishment of filling of battery cases as line of battery cases continues to move,
in-line capping mechanism for rendering capping of battery cases,
feed of part coordinated with in-line mechanisms of assembly of batteries,
in-line mechanisms serving jelly roll filling and cap-attaching actions, said mechanisms movable in coordination to movement of cases within moving line,
moving line of battery cases aligned to an in-line filler mechanism dispensing jelly rolls,
moving line of battery cases aligned to in-line capping mechanism.

23. The system of claim 22, further comprising at least one of battery assembly mechanism at least consistent with adaptation/derivation from bottle industry filling system mechanism, and at least one battery assembly mechanism at least consistent with adaptation/derivation from bottle industry capping system mechanism.

24. The system of claim 23, further comprising use in personal device of at least one finished battery of instant invention assembly line production.

25. The system of claim 24, further comprising said personal device use applied to at least one of energy storage use and home use.

26. The system of claim 23, further comprising at least one jelly roll of battery materials wound by motorized bobbin.

27. The system of claim 23, further comprising at least one supplier to said finished battery assembling from battery parts system, said supplier providing at least one support item of list: operations support for assembling batteries from parts, management support for assembling batteries from parts, logistical support for assembling batteries from parts, parts supply support for assembling batteries from parts, financial support for battery assembly from parts, construction support for assembling batteries from parts, marketing support for assembling batteries from parts.

28. A method for assembling finished batteries from battery parts, said method comprising at least one step at least consistent with step derivation/adaptation from method/step used in bottling industry, said at least one derived/adapted step for battery assembly of list:
positioning at least one battery case correctly for capping under capping chuck;
causing at least one capping chuck to correctly place battery cap on positioned battery case;
using reservoirs, bins and feeding chutes to enable timely feeding of battery parts into battery assembly line;
using gears, motorized drives, and control mechanisms for battery assembly under computer control;
using rotary motion of at least one starwheel to move battery case after battery case into position for respective filling;
moving continuously at least one battery case during assembly line sequence wherein case receives insertion of jelly roll of battery materials;
moving continuously at least one battery case during assembly line sequence wherein case receives attachment of battery cap;
maneuvering a battery cap in mutual coordination to automated positioning of battery case it will cap;
comprising battery cap placement of use of at least one of list: adhesive, pressure/snap-on motion, swivel/twist-on motion, receiving groove;
moving battery parts during battery assembly, said moving comprising sensor-related control;
using sensors to verify automated steps during battery assembly;
configuring and arranging multiple lines of battery parts supply comprising at least battery caps, and battery cases, the functioning of such supply lines comprising use of at least one computer;
coordinating placing jelly rolls of battery materials into battery cases, comprising at least one coordinating mechanism derivable from at least one filling-associated coordinating mechanism comprised in at least one bottling industry automated assembly line;
coordinating capping of battery cases during battery assembly, comprising at least one coordinating mechanism derivable from at least one capping-associated coordinating mechanism comprised in at least one bottling industry automated assembly line;
moving battery parts comprising use of interacting starwheels;
moving battery cases to progressively align said cases for each being filled with a jelly roll of battery materials;
moving battery cases, each containing a jelly roll of battery materials, to progressively align for capping.

29. The method of claim 28, further comprising at least one step of list:
positioning battery case after battery case into correct position to enable insertion of jelly roll,
aligning case with jelly roll filling position,
aligning case with capping position,
filling, and capping occurs in coordination to progressive movement of battery cases;
delivering finished batteries to collecting point,
filling and capping of battery cases, accomplished as line of battery cases continues to move,
arranging assembly line for case filling and capping by use of in-line filling mechanism and in-line capping mechanism,
feeding of battery part coordinated with in-line motion of partially assembled batteries,
completing filling with jelly roll of battery materials and capping with caps of moving battery cases, said moving towards the collection point,
affixing of caps onto battery cases accomplished comprising a moving line of battery cases aligned to in-line capping mechanism.

30. The method of claim 29, further comprising a step of using at least one of bottling industry filling method derived/adapted to use for battery assembly, and at least one bottling industry capping method derived/adapted to use for battery assembly.

31. The method of claim 30, further comprising a step of using in personal device at least one finished battery of instant invention assembly line production.

32. The method of claim 31, further comprising a step wherein said personal device use comprises at least one of use for energy storage and home use.

33. The method of claim 30, further comprising a step of winding at least one jelly roll of battery materials, said winding comprising use of motorized bobbin.

34. The method of claim 30, further comprising a step of supplying support for said battery assembly, said supplying comprising at least one of list: operations support for said assembling batteries from parts, management support for said assembling batteries from parts, logistical support for said assembling batteries from parts, parts supply support for said assembling batteries from parts, financial support for said assembling batteries from parts, construction support for said assembling batteries from parts, marketing support for said assembling batteries from parts.
